(19) United States
(12) Patent Application Publication
(10) Pub. No.: US 2002/0010596 A1
(43) Pub. Date: Jan. 24, 2002

(54) Remote patient care

(76) Inventor: Yvedt L. Matory, Dedham, MA (US)

Correspondence Address: Patent Group, Foley, Hoag & Elliot LLP, One Post Office Square, Boston, MA, 02109-2170, US

(21) Appl. No.: 09/835,197

(22) Filed: Apr. 13, 2001

Related U.S. Application Data
(60) Provisional application No. 60/196,699, filed on Apr. 13, 2000.
(60) Provisional application No. 60/218,949, filed on Jul. 14, 2000.

(51) Int. Cl. G06F 17/60

(52) U.S. Cl. 705/2

(57) ABSTRACT

The disclosure describes techniques for use in a remote patient care system such as a remote patient care system that connects patients and health care professionals over a network using video conferencing.

### REFERENCE TO RELATED APPLICATIONS

This application claims priority from co-pending U.S. provisional application, Ser. No. 60/196,699, filed Apr. 13, 2000; and co-pending provisional application, Ser. No. 60/218,949, filed Jul. 14, 2000. These applications are incorporated by reference in their entirety herein.

### BACKGROUND

Prolonged hospital stays significantly contribute to rising health care costs. Such stays also exacerbate “bed-shortages” experienced by many hospitals. Despite the strain of extended stays on care-givers, protracted time in a hospital does not necessarily translate into better quality-of-care for patients. For example, long hospital stays can increase risks of infection, medication error, and patient depression. Finally, despite lengthy stays, traditional discharge planning procedures often fail to provide adequate care to a patient after discharge.

A review of traditional post-operative care procedures following breast cancer surgery illustrate many treatment shortcomings described above. Typically, after undergoing a modified radical mastectomy or lumpectomy in a hospital setting, patients remain at the hospital from one to five days. Hospitals discharge patients after placing surgical drains in the surgical site. Often patients are left to manage their own dressings, monitor drainage, and adjust their own pain medication intake within the bounds of prescribed prescriptions. While, in some cases, a nurse will visit a patient at home to evaluate incisions, drainage, and vital signs, such visits may be abbreviated and far between.

Additionally, a patient must often coordinate their own care with many different providers. For example, patients must often schedule visits with a medical oncologist, radiation oncologist, breast cancer surgeon, and/or a plastic surgeon. Additionally, patients must often coordinate access to emotional and psychological services such as volunteer support, recovery aid, situational social workers, and psychiatric services supporting quality of life issues.

### SUMMARY

The disclosure describes techniques for use in a remote patient care system such as a remote patient care system that connects patients and health care professionals over a network using video conferencing.

In general, in one aspect, the disclosure describes a graphical user interface for use in a remote patient care system. The graphical user interface includes a first region depicting patient images received from a remote patient computer having a video camera and a concurrently displayed second region presenting a script guiding a user of the graphical user interface through a remote patient session.

Embodiments may include one or more of the following features. The script may be selected for a patient based on the patient's condition. The script may include conditional logic. The script may include instructions for presenting graphical user interface controls. The script may be downloaded from a networked computer. The interface may further include a third region presenting patient information collected by instrumentation other than the video camera such as vital sign values.

In general, in another aspect, the disclosure describes a method of remote patient care. The method includes collecting data reflecting operation of a remote patient care system that handles patients based on parameters, analyzing the collected data, and adjusting the parameters based on the analyzed collected data.

Embodiments may include one or more of the following features. The collected data may describe a patient outcome, health care costs, and/or patient satisfaction. The data may be collected from different health care sites. Handling patients may include determining patient eligibility for remote care and/or determining a remote care schedule for a patient.

In general, in another aspect, the disclosure describes a computer program product, disposed on a computer readable medium, for remote patient care. The computer program includes instructions for causing a processor to collect data reflecting operation of a remote patient care system that handles patients based on parameters, analyze the collected data, and adjust the parameters based on the analyzed collected data.

Potential advantages will become apparent in view of the following description, figures, and claims.

### BRIEF DESCRIPTION OF THE DRAWINGS

FIG. 1 is a diagram of a system for remote disease management.

FIG. 2 is a diagram of a graphical user interface presented to a care provider.

FIG. 3 is a diagram of a graphical user interface presented to a patient.

FIG. 4 is a flow-chart of a process for remote disease management.

FIG. 5 is a flow-chart of a process for adjusting a remote disease management process.

FIG. 6 is a diagram of a computer platform suitable for adjusting protocol criteria based on collected data.

### DETAILED DESCRIPTION

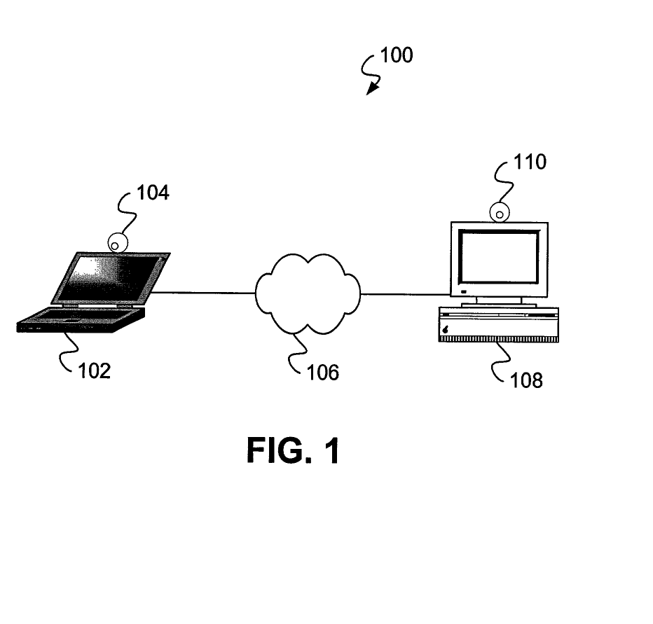

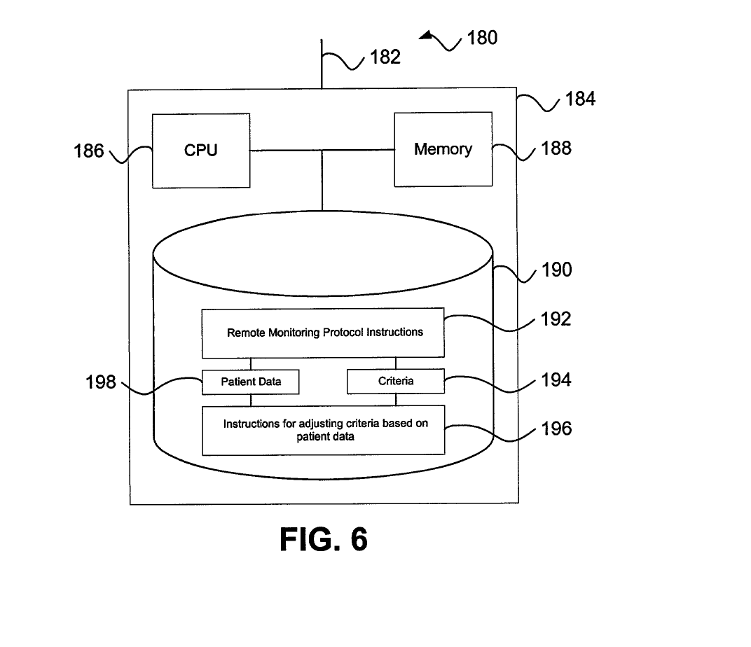

FIG. 1 shows a system 100 that enables health care professionals to remotely monitor and provide care to postoperative patients. As shown, the system 100 includes a patient's computer 102 and a health care provider's computer 108 that share data over a network 106 such as the Internet. While shown as a laptop 104, the patient's computer 102 may be a desktop model, Web TV, handheld device, wireless unit, and so forth. The system 100 may also include auxiliary computers such as an administrative computer (described in conjunction with FIG. 6).

Both patient and health care provider computers 102, 108 feature video cameras 104, 110 and microphones (not shown) for acquiring still-images, audio, and/or video data. The computers 102, 108 can communicate using network conferencing software such as Microsoft's NetMeeting or CUSeeMe. Instead of these off-the-shelf options, the computers 102, 108 may use dedicated conferencing/communication software developed for the system. Use of real-time conferencing enables health care professionals to provide patients with live interactive care without inconvenient travel to a hospital or extended time in a waiting room.

The system 100 offers an integrated approach to patient care and offers features that ensure proper treatment. For example, as explained below, the system 100 can dynamically adjust care parameters based on patient outcomes (e.g., whether complete recovery was achieved, how long recovery took, and so forth), satisfaction surveys, and other collected data. Additionally, as described below, the system 100 can provide a script for health care providers using the system 100 to maintain a high level of care.

The system 100 can enable hospitals to discharge post-operative patients earlier than traditionally contemplated while increasing the quality-of-care experienced by a patient. For example, patients more quickly return to the personal comfort and reassurance of home. Additionally, unlike patients discharged after a lengthy hospital stay, patients using the system 100 enjoy continued access to hospital staff.

In addition to greater patient satisfaction and improved quality-of-care, the system 100 offers cost savings to many in the health care landscape. For example, by decreasing the use of costly in-patient and out-patient resources, hospitals reduce the financial obligations of insurers and hospital networks. Additionally, remote monitoring can greatly increase the productivity of health care professionals. For example, a nurse using the system can quickly monitor many patients without leaving their chair.

The system 100 uses a number of safeguards to ensure patient confidentiality while transmitting data over the public network 106. For example, the system 100 can use standard methods of encryption such as using Secure Sockets Layer (SSL) software. To further enhance security, the system 100 independently transmits and encrypts visual, audio, text, health care metrics (e.g., vital signs), and other information. The system 100 may also make use of passcodes to enhance security. The exchange of information complies with Health Insurance Portability Accountability Act (HIPAA) regulations.

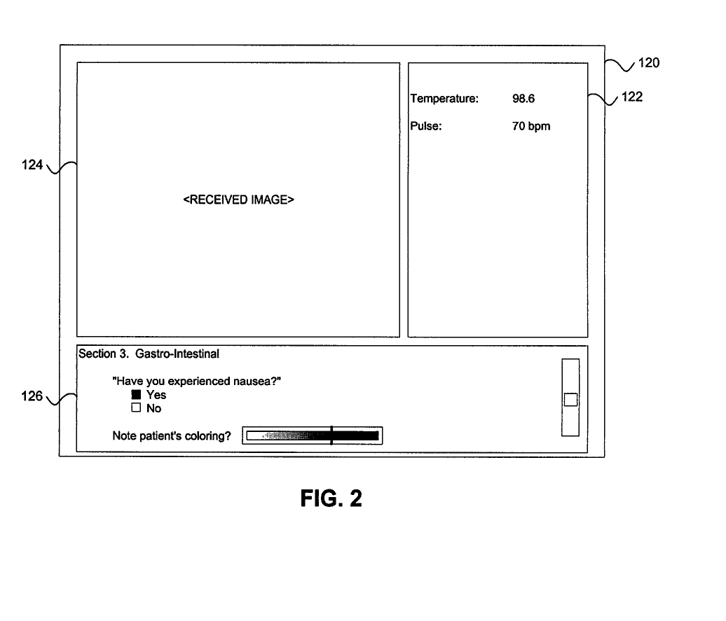

FIG. 2 shows an example of a user interface 120 presented to a health care professional during a remote care session. The interface 120 enables a professional to remotely assess patient status against disease management guidelines for the patient's clinical condition. The user interface 120 includes a region 124 for viewing image/video data transmitted by the patient's computer. The user interface 120 can also present other data collected and transmitted by the patient computer. For example, the patient's computer may be equipped with sensors and other devices for collecting heart rate, blood pressure, glucose levels, spirometry, and so forth. The user interface 120 can dynamically update the display of these values.

The information presented by the user interface 120 enables a nurse to gauge a patient's health, advise when a patient needs to be seen in the physician office, and alter the nurse to request other information or views of the patient. The user interface 120 may also provide controls (not shown) that enable the health professional to remotely control the patient's camera, for example, by changing its orientation and/or magnification.

As shown, the user interface 120 also presents a concurrently displayed script 126 region that provides guidance to a health care professional during a patient session. The script can remind the health care professional to ask certain questions, note particular aspects of a patient, and so forth. As shown, the script 126 can also receive data entry via familiar user interface control “widgets” such as radio buttons, sliding scales, text boxes, and so forth. As the nurse responds to script 126 questions and prompts, the script 126 instructions can store the responses and determine the next questions/statements to present.

The particular script 126 selected for use during a remote session may depend on the particular ailment, patient, duration since last visit, and other factors. Additionally, the script 126 may incorporate conditional logic that varies the questions/prompts presented based on the patients previous responses or other collected information. For example, if the health care computer receives vital sign data indicating a quickened pulse, the script 126 logic may cause a question to be presented asking whether the patient feels feint. Similarly, as shown, if a patient reports nausea, the script 126 may present a color slide bar for the health care professional to manipulate to match the patient's pallor. The script 126 may also, in programmed circumstances, direct the nurse to contact a physician, for example, by presenting a “button” for the nurse to select. Alternatively, the script 126 may automatically initiate physician contact, for example, by paging or sending an e-mail. The script 126 may be encoded in a variety of formats such as Java Applets stored at a particular URL (Universal Resource Locator).

The user interface 120 may present other information. For example, the interface 120 can graph collected data such as a graph of lung function over time. Additionally, the user interface 120 may provide access (not shown) to reference material for the health care professional conducting the remote session. Further, the user interface 120 may provide links (not shown) to other hospital facilities, for example, to schedule a visit with another health care professional.

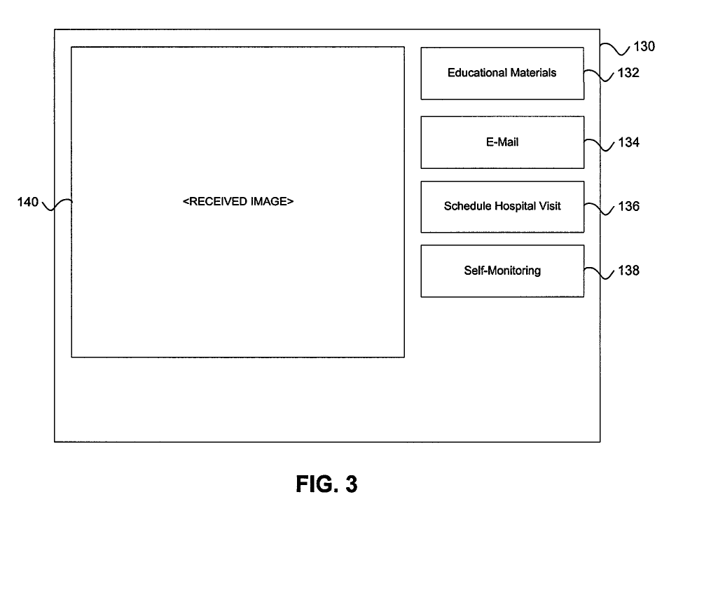

FIG. 3 shows an example of a user interface 130 presented to a patient. As shown, the interface 130 includes a region 140 for presenting images/video received from the health care computer. While not strictly necessary, presenting images of a health care provider can increase a patient's perception of personal attention.

As shown, the patient's user interface 130 also provides access to services that can be accessed even when a remote care session is not in progress. For example, the interface 130 provides access to personally tailored educational materials 132 that can let patients discover answers to common questions at their own pace. The interface 130 can also provide access to an e-mail 134 service that enables patients to e-mail information to a health care provider. For example, a patient can send an e-mail to a doctor or nurse that includes a still image or video of an operation site and the text of a question regarding the image(s). The user interface 130 can also provide access to other hospital systems, for example, to schedule appointments 136, check staff credentials, check prescriptions, and so forth.

The system may also enable a patient to interact with their own treatment plan off-line. For example, the patient's computer may receive computer instructions and/or data from a health care provider that can automatically provide features traditionally provided by human health care providers. For example, the instructions can provide video or text that guides a patient through a data acquisition process (e.g., taking vital signs). For instance, for a diabetes patient, the instructions may describe and depict a series of steps needed to take a glucose measurement with equipment connected to the patient's computer. The instructions may respond to a received measurement and other information (e.g., answers to additional questions, previous measurements, and a doctor's treatment plan encoded in the instructions or data) by suggesting a patient action. To continue the example of a diabetes patient, the instructions may suggest the taking 10 mg of insulin. In more serious cases, the instructions may automatically initiate contact (e.g., page or e-mail) with hospital personnel or instruct the patient to do so.

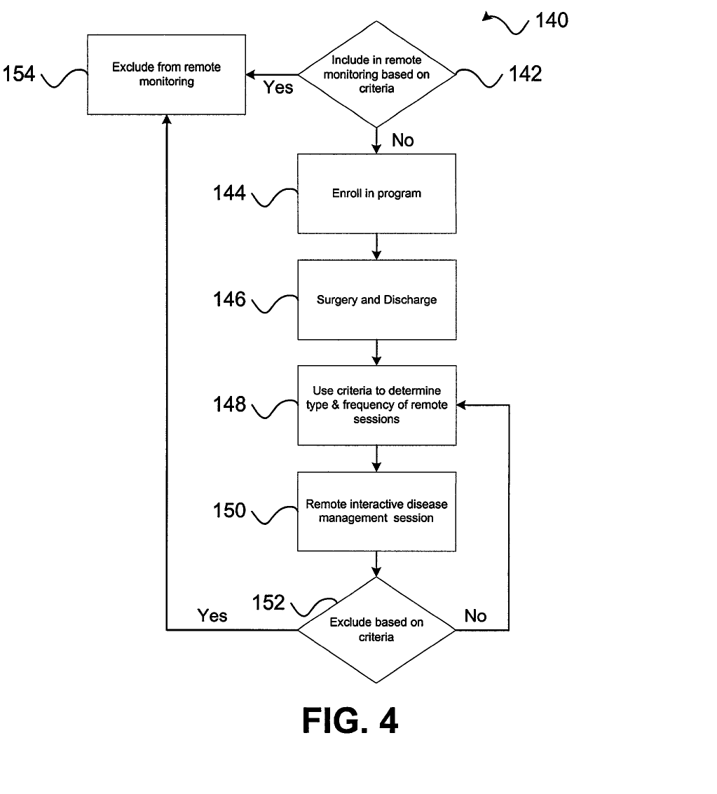

FIG. 4 illustrates a protocol 140 for use with the remote disease management system. The protocol 140 helps ensure that remote care does not replace in-person care needed by some patients. The protocol 140 also helps tailor the remote care process to the needs of a particular patient. For example, the protocol 140 can adjust the frequency of remote monitoring sessions based on patient characteristics.

The protocol 140 shown is merely exemplary and may vary at different sites and for different illnesses. For illustration purposes, this application describes the protocol 140 within the context of a remote monitoring protocol 140 for breast cancer patients.

After a breast cancer patient consents to a surgical treatment that normally requires hospital admission (e.g., a mastectomy, mastectomy with implant reconstruction, or wide excision with axillary node dissection), patient characteristics are compared 142 to criteria to determine whether remote monitoring is appropriate for the patient. Such criteria may include criteria requiring a patient to live within a certain threshold driving distance to a hospital, have a telephone line, have some self-reported or observed familiarity with computers, reside in a home within someone able to assist with physical care, have no co-morbid diseases, a physician referral, and so forth. These criteria are merely examples. Again, these criteria may be removed or altered and others added based on patient satisfaction, outcomes, financial impact, and so forth.

The protocol 140 enrolls 144 patients that meet these criteria and that agree to participate. Enrolled patients receive a computer and instructions, for example, when they come to the hospital for pre-surgery testing. Patients meet with the nursing staff that will be giving them the post-operative computer visits. To confirm that they understand the use of the computer, patients receive a trial computer visit prior to their surgery.

After surgery and discharge 146, patients receive scheduled remote interactive disease management visits 150. For example, the patient may receive an e-mailed schedule identifying times to turn on their computers.

During the remote disease management visits 150, nurses use the system to remotely interact with patients and respond in real time. For example, nurses can ask the patients specific questions, examine their surgical wounds, review care procedures, and so forth, for example, in accordance with the script described in conjunction with FIG. 3. For instance, in response to a patient's comment that they have felt short of breath, a script may suggest asking the patient to puff air into equipment attached to the patient's computer. In addition to receiving data from the attached equipment, the nurse can note the patient's appearance as presented by the received video image. Again, the data collected during the interactive visit is stored for subsequent analysis and, potentially, adjustment of protocol 140 criteria.

Enrollment does not limit patient access to more traditional care. For example, patients may call the tele-monitoring nurse or their doctor at any time, request a home visit, and/or schedule an appointment at a hospital. Additionally, even where remote visits form a portion of a patients care, a protocol 140 may schedule both remote and in-person appointments. An in-person post-operative appointment with a surgeon is typically scheduled for 10-14 days after surgery. Assuming a satisfactory outcome, the patient returns the computer, completes a satisfaction questionnaire, and the patient's participation in the protocol 140 ends.

Through-out the study, the protocol 140 determines 152 whether remote monitoring continues to offer an effective method of patient care. Again, the protocol 140 may use different criteria to make this determination 152. For example, the protocol 140 may evaluate a patients vital signs for instability (e.g., a temperature greater than 100, blood pressure less than 90/60 or over 160/100, and/or a pulse greater than 110), evidence of wound bleeding (e.g., conspicuous hematoma or drainage output greater than 100 cc in the first four hours), and/or inadequate pain control as reported and noted by the remote nurse.

The protocol 140 also uses criteria to determine 148 the type and frequency of remote monitoring. For example, the protocol 140 may use patient answers, staff notations, and other collected data to determine a time for the next visit(s). For instance, a slowly recovering patient may be scheduled for a next appointment at an earlier date than a quickly recovering patient.

As described above, in addition to health-based factors, the criteria described above may incorporate resource management considerations. For example, enrollment criteria may depend on the number of nurses trained in use of the system or other resources.

Though described in conjunction with a breast cancer treatment program, the system described above can apply to many different diseases or disease states currently treated on an inpatient basis. For example, the system can promote early discharge of congestive heart failure (CHF) and asthma patients by offering each preventive care education, monitoring adherence to self-care programs, and gauging patient response to treatment. The system is very useful for remote wound care monitoring such as chronic leg ulcer management. Frequent monitoring and online reinforcement of self-care instructions can postpone or completely avoid the devastating affect of poorly attended skin trauma. The remote monitoring system can also play an important role in treatment of diabetes and reducing in-patient days. For example, individuals with diabetes who have had an imbalance of serum glucose requiring inpatient management but who now have stable chemical results and stable cardio-respiratory status. Patient education, early preventive care, and consistent monitoring are important weapons in preventing many of the devastating vascular consequences of diabetes. The remote monitoring system can also facilitate early discharge for stable maternity patients and offer convenient home care for infants and mothers during the postpartum period.

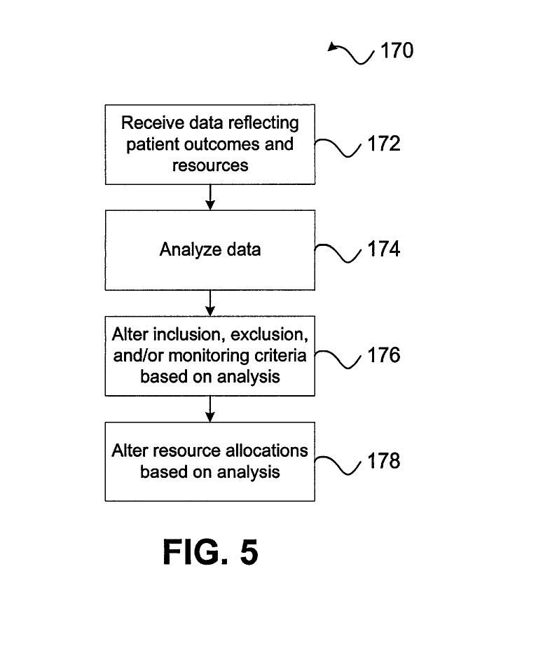

Referring to FIG. 5, the system continually monitors and reacts to the quality and cost of care received by remotely monitored patients. For example, the system may store and statistically analyze data describing patient outcomes, compliance, adverse events, and so forth. The system also monitors costs, charges, and reimbursement of the health care services as well as satisfaction surveys of physicians, payors, and vendors.

Based on this data, the system can modify criteria described above. For example, the system may automatically analyze the data to identify high correlations between criteria parameters and patient satisfaction, outcomes, or data reflecting a high cost. For example, if after time, statistical analysis of data indicates that patients over a certain age do not perform well with remote monitoring, the system may automatically raise the age criteria threshold for continued or initial participation. As another example, the system may identify certain patient conditions requiring more frequent remote sessions and correspondingly alter the protocols remote session frequency for such patients.

The system may also aggregate data from different sites for comparison and subsequent modification of the protocol criteria. For example, the system may consider analyzing monthly and year-to-date results for aggregated member months, total inpatient costs, inpatient costs, total health provider admissions, admissions by inpatient facility, total inpatient days, inpatient days by health center provider, inpatient days by inpatient facility, and capitation revenue for inpatient care. Additionally, the system may consider average capitation revenue per member per month, average cost for inpatient care, number of admissions per 1000 members per year, number of patient days per 1000 members per year, average length of stay, average cost per day by facility, average cost per admission by facility, average length of stay by inpatient facility. The system may further evaluate on nursing time and activities. Again, based on analysis of this data, the system may automatically adjust the protocol, for example, by altering its criteria.

FIG. 6 depicts a computer 184 suitable for implementing aspects of the techniques described herein. As shown, the computer 184 includes a CPU 186 (Central Processing Unit), volatile memory 188, and non-volatile memory 190. The non-volatile memory 190 can store instructions 192 for implementing a protocol. The non-volatile memory 190 may also include instructions 196 for adjusting the protocol in response to collected data. Such instructions 196 may include instructions for statistically analyzing patient data 198 or other collected data. In the course of operation, the instructions 192, 196 are transferred from the non-volatile memory 190 to the volatile memory 188 and/or the CPU 186 for execution.

As shown, the computer 184 may also store protocol criteria and logic 194. The protocol logic 194 may be encoded using any of a variety of computer languages. The computer 184 may also store other information such as scripts (not shown) for use by health care professionals during a remote session and instructions that enable a user to access their treatment plan off-line.

As shown, the computer also features a network connection 182. As such, the features described above may be distributed across many different computers. For example, one computer may store patient data while another stores scripts for transmission to care taker computers.

The techniques described herein, however, are not limited to any particular hardware or software configuration. The techniques may be implemented in hardware or software, or a combination of the two. Preferably, the techniques are implemented in computer programs executing on programmable computers that each include a processor, a storage medium readable by the processor (including volatile and non-volatile memory and/or storage elements), at least one input device, and one or more output devices.

Each program is preferably implemented in high level procedural or object oriented programming language to communicate with a computer system. However, the programs can be implemented in assembly or machine language, if desired. In any case the language may be compiled or interpreted language.

Each such computer program is preferably stored on a storage medium or device (e.g., CD-ROM, hard disk, or magnetic disk) that is readable by a general or special purpose programmable computer for configuring and operating the computer when the storage medium or device is read by the computer to perform the procedures described herein. The system may also be considered to be implemented as a computer-readable storage medium, configured with a computer program, where the storage medium so configured causes a computer to operate in a specific and predefined manner.

Other embodiments are within the scope of the following claims.

What is claimed is:

1. A graphical user interface for use in a remote patient care system, the graphical user interface comprising:
a first region depicting patient images received from a remote patient computer having a video camera; and
a concurrently displayed second region presenting a script guiding a user of the graphical user interface through a remote patient session.

2. The graphical user interface of claim 1, wherein the script comprises a script selected for a patient based on the patient's condition.

3. The graphical user interface of claim 1, wherein the script comprises a script including conditional logic.

4. The graphical user interface of claim 1, wherein the script comprises a script including instructions for presenting graphical user interface controls.

5. The graphical user interface of claim 1, wherein the script comprises a script downloaded from a networked computer.

6. The graphical user interface of claim 1 further comprising a third region presenting patient information collected by instrumentation other than the video camera.

7. The graphical user interface of claim 6, wherein the information comprises vital sign values.

8. A method of remote patient care, the method comprising:
collecting data reflecting operation of a remote patient care system that delivers one or more images of a patient to a care provider's computer over a network, the remote patient care system handling patients based on parameters;
analyzing the collected data; and
adjusting the parameters based on the analyzed collected data.

9. The method of claim 8, wherein the collected data reflecting operation of a remote patient care system comprises data describing a patient outcome.

10. The method of claim 8, wherein the collected data reflecting operation of a remote patient care system comprises data describing health care costs.

11. The method of claim 8, wherein the collected data reflecting operation of a remote patient care system comprises data describing patient satisfaction.

12. The method of claim 8, wherein the collected data reflecting operation of a remote patient care system comprises data collected from different health care sites.

13. The method of claim 8, wherein handling patients comprises determining patient eligibility for remote care.

14. The method of claim 8, wherein handling patients comprises determining a remote care schedule for a patient.

15. The method of claim 8, wherein the parameters comprise thresholds.

16. The method of claim 8, wherein the patients comprise post-operative breast cancer patients.

17. The method of claim 8, wherein the network comprises the Internet.

18. A computer program product, disposed on a computer readable medium, for remote patient care, the computer program includes instructions for causing a processor to:
collect data reflecting operation of a remote patient care system that delivers one or more images of a patient to a care provider's computer over a network, the remote patient care system handling patients based on parameters;
analyze the collected data; and
adjust the parameters based on the analyzed collected data.
